(19) United States
(12) Patent Application Publication
(10) Pub. No.: US 2016/0203017 A1
(43) Pub. Date: Jul. 14, 2016

(54) BASEBOARD MANAGEMENT CONTROLLER PROVIDING PEER SYSTEM IDENTIFICATION

(71) Applicant: HEWLETT PACKARD ENTERPRISE DEVELOPMENT LP, Houston, TX (US)

(72) Inventors: Chris Davenport, Houston, TX (US); Lee A Preimesberger, Houston, TX (US); Eric A Ramirez, Houston, TX (US); Tess Muir, Houston, TX (US); Sangita Prajapati, Houston, TX (US); Jorge Daniel Cisneros, Houston, TX (US); James Ayvaz, Houston, TX (US); Thomas A Schwartz, Tomball, TX (US)

(21) Appl. No.: 14/916,482

(22) PCT Filed: Sep. 25, 2013
(86) PCT No.: PCT/US2013/061582

§ 371 Date: Mar. 3, 2016

(51) Int. Cl. G06F 9/455; G06F 17/30; H04L 29/08

(52) U.S. Cl. CPC G06F 9/45558; H04L 67/1097; G06F 17/30203; G06F 2009/45595; G06F 2009/45583; G06F 2009/4557

(57) ABSTRACT

A server system may include a baseboard management controller and a host system. The baseboard management controller may obtain an identification of a peer system over a management network connection. The baseboard management controller may provide the identification of the peer system to the host system. The host system may use the identification of the peer system to obtain a virtual machine image.

### BACKGROUND

Some server platforms may include baseboard management controllers (BMCs). A BMC may include an independent operating environment and a management processor. The management processor may reside on the system board, use auxiliary power, and operate independently of the host processor and host operating system. The BMC may be connected to a management network that is independent of a production network to which the host connects. A BMC may be used to provide various functions, including remote power control, remote access to access server status and diagnostics, remote access system alerts, and remote console functionality.

### BRIEF DESCRIPTION OF THE DRAWINGS

Certain examples are described in the following detailed description and in reference to the drawings, in which:

FIG. 1 illustrates an example server network having connected BMCs;

FIG. 2A illustrates an example system having a BMC to provide a peer system identification to a host system;

FIG. 2B illustrates a further example system having a BMC to provide a peer system identification to a host system;

FIG. 3 illustrates an example server system having a host system including a non-transitory computer readable medium storing instructions to implement a hypervisor;

FIG. 4 illustrates an example BMC storing a shared directory.

### DETAILED DESCRIPTION OF SPECIFIC EXAMPLES

A server network may include a number of servers, or nodes, connected by a network. For example, a server network may include hundreds, thousands, or millions of interconnected servers. A server network may be divided into groups. A group may include one server or the entire network. In some cases, a single server may be a member of more than one group. Additionally, a group may be a subset of another group (“a parent group”).

In some server networks, virtual machines are executed on the servers. In some cases, virtual machines may be migrated between servers of a group. For example, if the resources of a host server are underutilized by its virtual machines, virtual machines from other peer servers may be transferred to the host server to more efficiently utilize the host server resources. In some cases, a server may be powered down if it is not needed to execute any of the group's virtual machines. The server may be powered up later if the group's virtual machines require additional resources.

In some implementations, various data may be distributed across the servers in a group. For example, configuration data, such as settings, drivers, software updates, may be distributed across the servers in the group, so that the servers have a unified configuration.

In some networks, group-wide data distribution and virtual machine migration are performed by management or control systems that are external to the server group. For example, a deployment server may be used to distribute configuration data to the servers in a group. As another example, a virtual machine management application may be executed by a management node. The management application may enable migrations and mesh multiple servers into a single group. Such management system may use network resources, require manual configuration, and represent a potential point of failure.

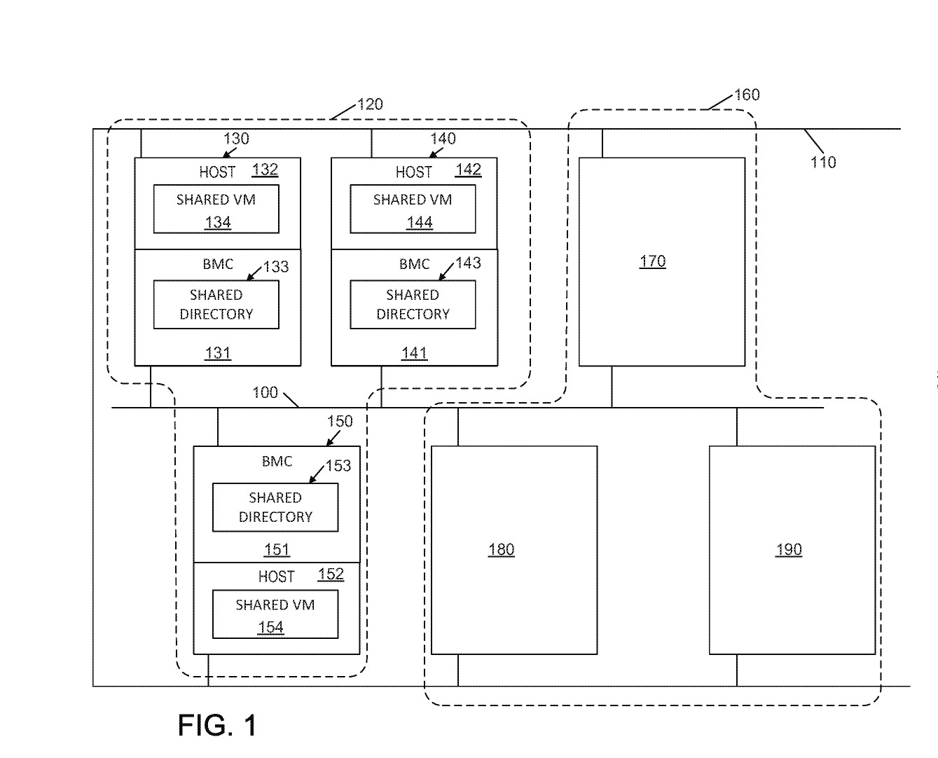

Some implementations of the disclosed technology may use a network of baseboard management controllers (BMC) to share configuration data and enable virtual machine migration between servers. As an example, FIG. 1 illustrates an example server network having connected BMCs. The example network includes servers 130, 140, 150, 170, 180, 190 grouped into a first server group 120 and a second server group 160. In some implementations, a server may be a member of more than one group. For example, each server in a network or may be a member of a master group and may be a member of one or more smaller groups.

In this example, the servers 130, 140, 150, 170, 180, 190 are connected by a production network 110. For example, the production network 110 may be an Ethernet local area network (LAN) used by the servers 130, 140, 150, 170, 180, 190 for network communications. The servers 130, 140, 150, 170, 180, 190 are also connected by a management network 100. For example, the management network 100 may be an Ethernet LAN connecting BMCs 131, 141, 151. In some implementations, the management network 100 may he a separate physical network. In other implementations, the management network 100 may be a virtual network, such as a virtual private network (VPN), implemented on the production network 110.

Example server group 120 may include servers 130, 140, 150. Each server 130, 140, 150 may include a BMC 131, 141, 151 and a host system 132, 142, 152. The BMCs 131, 141, 151 may use the management network 100 to share contents of shared directories 133, 143, 153. For example, the shared directories 133, 143, 153 may be directories stored on flash memory. In some implementations, the shared directories 133, 143, 153, may store peer identification information, configuration files, statuses, or other binary large objects (BLOBs). For example, the shared directories 133, 143, 153 may store information allowing the BMCs 131, 141, 151 to identify the members of the server group 120. As another example, the shared directories 133, 145, 153 may store driver updates or settings for the BMCs 131, 141, 151 to apply to the host systems 132, 142, 152.

In some implementations, the BMCs 131, 141, 151 each have a neighbor peer BMC in the group 120. The information in the shared directories 133, 143, 153 may be updated by each BMC 131, 141, 151 updating its shared directory 133, 141, 153 according to the contents of its neighbor. For example, if BMC 131 has BMC 141 as a neighbor, then BMC 131 may compare the contents of its shared directory 133 with the contents of its neighbor BMC's shared directory 143. BMC 131 may update its shared directory 133 if the neighbor shared directory 143 has newer or updated contents. In some implementations, the BMCs 131, 141, 151 may maintain fields such as timestamps and deletion flags associated with contents of the shared directories 133, 143, 153. Such fields may assist in the updating process. In some implementations, the BMCs of a group 120, 160 may be organized in a ring topology, where each BMC is assigned a single neighbor. In other implementations, the BMCs 131, 141, 151 may he organized into other topologies, such as partially or fully connected mesh topologies, tree topologies, star topologies, or hybrid topologies.

As an example, a system administrator may load a driver update into shared directory 133. The BMC 131 may then provide the driver update to its neighbor—for example, BMC 143—when BMC 143 updates its shared directory 143. BMC 143 may then provide the driver update to its neighbor for example. BMC 153—when BMC 153 updates its shared directory 153. The driver update may then be propagated throughout the entire group 120 without using shared network storage, scripting, or a system management infrastructure. As other examples, update notifications, network settings, domain name server (DNS) settings, status updates, group membership identifications, and other configuration information may be propagated throughout groups 120, 160.

In some implementations, the host systems 132, 142, 152 in the server group 120 may share images 134, 144, 154 of a virtual machine. The images 134, 144, 154 may include any data and state information needed to instantiate and execute the virtual machine. The host systems 132, 142, 152 may use the production network 110 to share the images 134, 144, 154. In some implementations, the images 134, 144, 154 may be entire copies of virtual machines or may be difference files (deltas) that contain the differences between a later version of the virtual machine and an earlier version of the virtual machine. For example, if a virtual machine is installed on host system 131, it may maintain an image 134 of the virtual machine as it is executed. Initially, the host system 132 may share the image as a copy of the virtual machine. Subsequently, the host system 132 may share the image as deltas describing the current state of the virtual machine as compared to a previous state of the virtual machine. In this example, the host systems 142, 152 may use the initial copy and the deltas to maintain a current image 144, 154 of the virtual machine. In some implementations, one of the host systems 132, 142, 152 executes the virtual machine at a given time. The other host systems 132, 142, 152 may instantiate the image 132, 142, 152 to begin executing the virtual machine if the previously executing host system 132, 142, 152 ceases to execute the virtual machine.

In some implementations, the BMCs 131, 141, 151 provide identification of peer systems to their respective host systems 132, 142, 152. For example, the BMCs 131, 141, 151 may receive peer system identifications over the management network 100 from other BMCs 131, 141, 151. For example, a BMC 131, 141, 151 may obtain peer system identifications from the shared directory 133, 143, 153. In further implementations, the BMCs 131, 141, 151 may provide peer system status identification to their host systems 132, 142, 152. For example, if host system 132 becomes unstable, the BMC 131 may update its shared directory 133 with an unstable system status indication. The status indication may then be shared with BMCs 141, 151 when the BMCs 141, 151 update their shared directories 143, 153. The BMCs 141, 151 may then alert their host systems 142, 152 that host system 132 has become unstable and that they should Lake over execution of the virtual machine 144, 154. In some implementations, the host systems 142, 152 may communicate on the production network 110 to decide which system will instantiate the virtual machine image 144, 154. For example, the host system 142, 152 with the most available computing resources may instantiate the virtual machine image 144, 154.

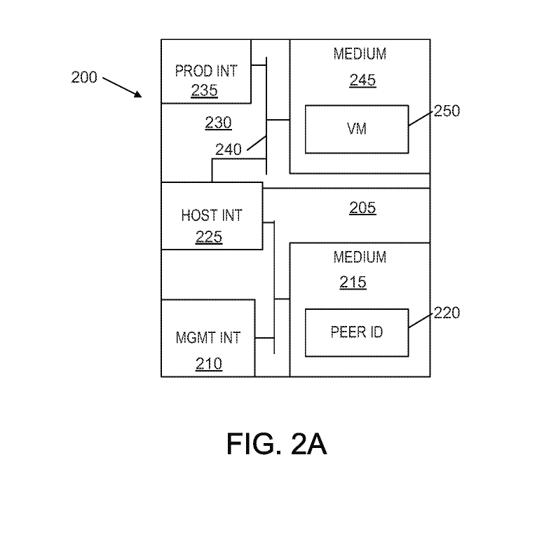

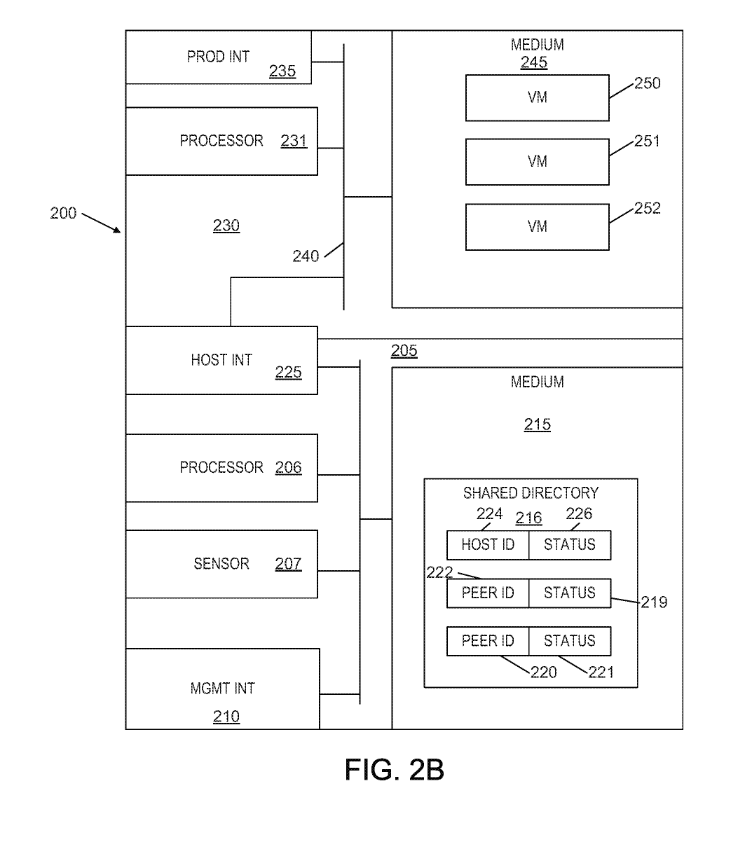

FIG. 2A illustrates an example system 200 having a BMC 205 to provide a peer system identification 220 to a host system 230. In some implementations, the example system 200 may be a server that may he a member of a server network or server group. For example, the example system 200 may be a server 130, 140, 150, 170, 180, or 190 as described with respect to FIG. 1.

The example system 200 may include a baseboard management controller (BMC) 205 coupled to a host system 230. The BMC 205 may include a management network interface 210 to connect to a management network. In some implementations, the management network interface 210 may he a network interface card to connect to a management network. In other implementations, the management network may be coexistent with a production network used for communication by the host system 230. For example, the management network may be a virtual private network on the production network. In these implementations, the management network interface 210 may be a network interface card to connect to the management network or may be a connection to a network interface card on the host system 230. For example, the host system may have a production network interface 235 to connect to the production network. In this example, the management network interface 210 may be a connection to the production network interface 235.

The BMC 205 may use the management network interface 210 to receive an identification of a peer system over the management network. For example, the identification of the peer system may be an address or identifier of a peer BMC, a peer host system, or both. In some implementations, the peer system may be another server system in the server network, another server system in the same group or parent group as the example system 200, or another server system in the same server group as the example system 200.

The BMC 205 may include a non-transitory computer readable medium 215 to the store the identification of the peer system 220. In some implementations, the non-transitory computer readable medium 15 may include random access memory (RAM), storage, such as flash memory, or a combination thereof.

The example system 200 may include a host system interface 225 coupled to the BMC 205 and the host system 230. In some implementations, the host system interface 225 may comprise a connection to a host system bus 240. For example, the bus 240 may be a Peripheral Component Interconnect (PCI) Express (PCIe) bus. In further implementations, the interface 225 may include bridge or firewall functions.

The host system 230 may include a production network interface 235. For example, the production network interface 235 may be an Ethernet port connected to an Ethernet network used by the system 200 for general network communications. The production network interface 235 may receive an image 250 of a virtual machine hosted by the peer system identified by the identifier 220. For example, the host system 230 may receive the image 250 directly from the peer system or may receive the image 250 from a network attached storage to which the peer system uploads images of the virtual machine.

The host system 230 may also include a second non-transitory computer readable medium 245. For example, the second non-transitory computer readable medium 245 may include RAM, storage, or a combination thereof. The medium 245 may store the image 250 of the virtual machine.

FIG. 2B illustrates a further example of a server system 200. In this example, the first medium 215 stores the identification of the peer system 220 in a shared directory 216. For example, the contents of the shared directory 216 may be shared among server systems in a server network or server group. In some implementations, the medium 215 may store multiple shared directories. For example, if the system 200 belongs to multiple server groups, the medium 215 may store a shared directory for each server group.

The BMC may include a processor 206 to maintain the shared directory 216. For example, the processor 206 may use the management interface 210 to communicate with a peer BMC to compare the shared directory 216 with a peer shared directory. The processor 206 may use the management network interface 210 to receive the identification 220 from the peer BMC. In some cases, the identification 220 may identify the peer BMC or the peer BMC's host system. In other cases, the identification 220 may identify another peer BMC or another peer BMC's host system. For example, if system 200 corresponds to system 130 of FIG. 1, the identification 220 may be received from BMC 141 and may identify system 140 or may identify system 150.

In some implementations, the processor 206 may determine that the peer shared directory includes a plurality of files. For example, the processor 206 may use the management interface 210 to communicate with the peer system storing the peer shared directory to determine that the peer shared directory includes a plurality of files. Additionally, the processor 206 may inspect the contents of the peer shared directory. For example, for each file of the peer shared directory, the processor may determine if there is a corresponding file in the shared directory 216. If there is not a corresponding file in the shared directory 216, the processor may create the corresponding file in the shared directory 216. In some implementations, the processor may create the corresponding file by copying the file from the peer shared directory. For example, the processor may initially obtain the peer identification 220 by copying it from the peer shared directory.

In some implementations, the identification 220 of the peer system is stored with a peer system status indication 221. For example, the peer system status indication 221 may indicate whether the peer system identified by identification 220 is online or offline, whether it is stable or unstable, or may indicate the peer system's computational resource utilization. For example, if the peer system becomes unstable, the peer system's BMC may update its status indication indicating that the peer system is offline. The BMC 205 may obtain the updated status indication when it updates the shared directory 216.

The BMC processor 206 may signal the host system 230 that the peer system is offline 205 may provide the status indication to the host system 230. For example, the BMC processor 206 may provide the status indication 226 to the host system 230 using the host system interface 225. If the status indication 221 indicates that the peer system is offline, then the host system 230 may instantiate the image 250 of virtual machine and take over execution of the virtual machine.

In some implementations, the BMC 205 may use the management network interface 210 to receive a request to execute the virtual machine corresponding to image 250. For example, the request may be received from the peer system identified by identifier 220. The BMC 205 may provide the request to the host system 230. The host system 230 may include a processor 231 to instantiate the virtual machine using the image 250. In some implementations, the host system 230 may be powered down until needed. Upon receiving the request, the BMC 205 may power on the host system 230 and provide the request.

In some implementations, the management network interface 210 may receive a second identification 222 of a second peer system. In some cases, the interface 210 may receive the second identification 222 from the first peer system. For example, the first peer system may obtain the second identification 22 form the second peer system. The management network interface 210 may receive the second identification 222 when the BMC 205 updates its shared directory 216. The host system interface 225 may provide the second identification 224 to the host system 230.

In these implementations, the production network interface may receive a second image 252 of a second virtual machine and the medium 245 may store the second image 252. For example, the second image 252 may be of a virtual machine hosted by the second peer system. The second image 252 may be obtained in manner similar to the first image 250. For example, the second image 252 may be obtained from the first peer system, from the second peer system, or from a network attached storage.

In some implementations, the shared directory 216 stores an identification 224 of the host system 230. In these implementations, the management network interface 210 may send the identification 224 of the host system to a peer system over the management network. For example, the management network interface 210 may send the identification 224 when a peer BMC of the peer system updates its shared directory with the contents of the shared directory 216. For example, the management network interface 210 may send the identification to the peer BMC from which it received the peer identification 222.

In these implementations, the production network interface 235 may send an image 251 of a second virtual machine to the peer system over the production network. For example, the production network interface 235 may send the image 251 directly to the peer system or to another system from which the peer system may obtain the image 251. In some cases, the image 251 may be an image of a virtual machine executed by a processor 231 of the host system 230. For example, the second virtual machine may be a virtual machine that is installed and running on the host system 230.

In some implementations, the host system 230 may use the management network interface 235 to send a request to execute the virtual machine to the peer system. For example, if the host system's 230 computing resources are underutilized, the host system may begin a shutdown procedure by requesting its peer systems to execute its virtual machines. As another example, if the host system's 230 computing resources are overutilized, the host system 230 may request that the peer system take over execution of the second virtual machine to reduce computing resource utilization. After sending the request, the processor 231 may cease executing the second virtual machine.

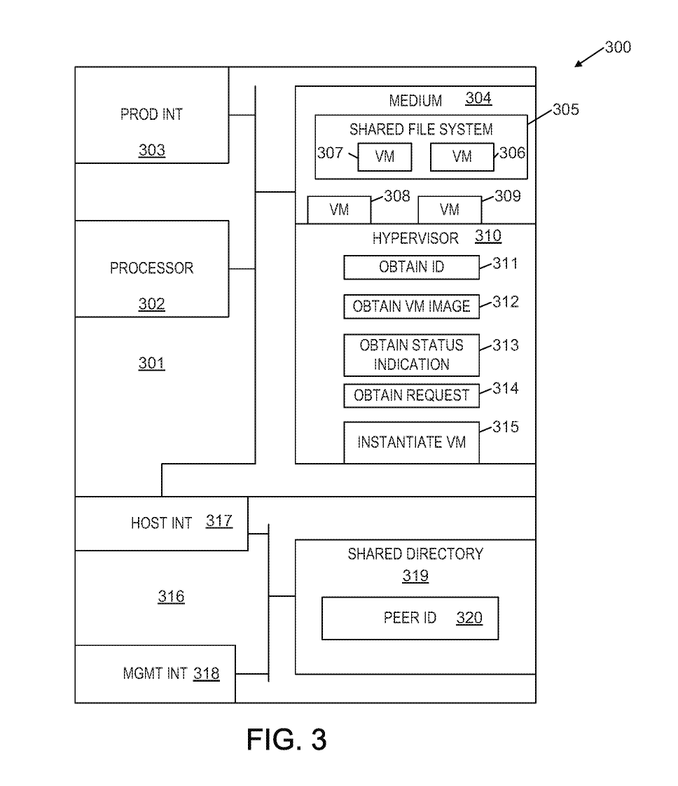

FIG. 3 illustrates an example server system 300 haying a host system 301 including a non-transitory computer readable medium 304 storing instructions 310 to implement a hypervisor. For example, the hypervisor instructions 310 may be executed by a processor 302 of the host system 301. In some implementations, the example server system 300 may function in a server network, such as the server network illustrated in FIG. 1.

In this example, the hypervisor instructions 310 may include instructions 311 that, when executed, obtain an identification of a peer system 320 from a shared directory 319 stored by a BMC 316. For example, the instructions 311 may be executed by the processor 302 to receive the identification 320 from a host system interface 317 of the BMC. For example, the BMC 316 may receive the identification 320 through a management network interface 318 and may present the shared directory 319 to the host system 301 as stored on a virtual media device.

Additionally, the hypervisor instructions 310 may include instructions 312 that may be executed to obtain an image 306 of a virtual machine from the peer system. For example, when executing the instructions 312, the processor 302 may use a production network interlace 303 to obtain the image 306. For example, when executed the hypervisor may claim storage and memory space 304 to create a copy 305 of a shared file system. For example, the hypervisor may create the copy 305 by copying the shared file system from the peer system identified by identification 320.

In some implementations, the hypervisor instructions 310 may include instructions 313 that may be executed to obtain a status indication. For example, when executed, the processor 302 may obtain the status indication from the BMC 316. For example, the status indication may be obtained by the BMC 316 from the peer system and stored with the peer identification 320. In some cases, the status indication may indicate that the peer system is offline. The hypervisor instructions 310 may include instructions 315 that are executable by the processor to instantiate and execute the virtual machine 308 corresponding to the virtual machine image 306.

In further implementations, the hypervisor instructions 310 may include instructions 314 that may be executed to obtain a request to execute the virtual machine 308 corresponding to the image 306. In some cases, the host system 301 may obtain the request via the production interface 303. For example, the request may be sent by the peer host system previously executing the virtual machine 308 to allow the peer host system to reduce its computational load.

In some implementations, the instantiation instructions 315 may be executed to instantiate a second virtual machine 309. The instructions 315 may be further executed to store a second image 307 of the second virtual machine 309 in the shared file system 305. Additionally, the hypervisor instructions 310 may be implemented to send the second image 307 to the peer system. For example, a peer hypervisor running on a peer system may obtain a copy of the second image 307 from the host system 301 by updating its copy of the shared file system 305.

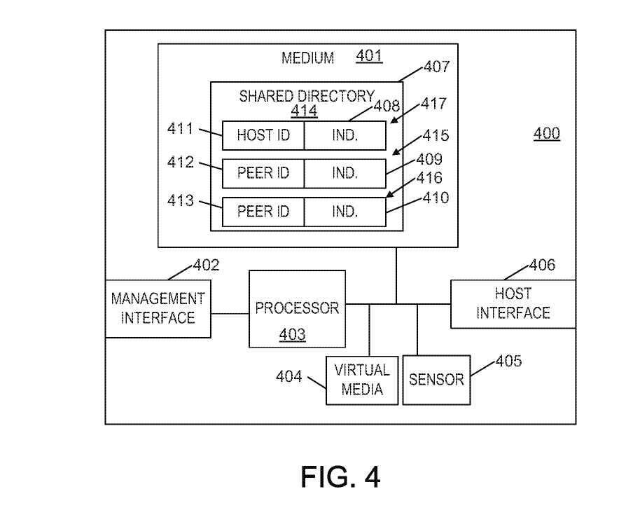

FIG. 4 illustrates an example BMC 400 storing a shared directory. For example, the BMC 400 may he a BMC in a server system of the type illustrated with respect to FIGS. 1-3.

The example BMC 400 may include a non-transitory computer readable medium 401 to store a shared directory 414. In some implementations, the contents of the shared directory 414 may be shared among BMCs in a server network or a server group in a server network. The shared directory 214 may include an identification 412 of a peer system. For example, the identification 412 may identify a BMC of a peer server system, a host system of a peer server system, or both.

The example BMC 400 may also include a management network interface 402 to connect to a management network. For example, the management network interfaced 402 may connect to a management network 100 as described with respect to FIG. 1. The BMC may also include a host system interface 406 to connect to a host system. For example, the host system interface 406 may he similar to the host system interface 225 described with respect to FIGS. 2A-2B.

The example BMC 400 may also include a processor 403. In some implementations, the processor 403 may use the management network interface 402 to receive the identification 412 of the peer system. For example, the processor 402 may receive the identification 412 from the peer system. As another example, the processor 402 may receive the identification 412 from a second peer system.

The processor 403 may use the host system interface 406 to provide the identification 412 of the peer system to the host system. For example, the processor 403 may present the shared directory 407 as a directory in a virtual media drive 404, such as a virtual Universal Serial Bus (USB) drive, connected to the host system's PCIe bus.

In some implementations, the processor 403 may update the shared directory 414 by comparing a local file 415 stored in the shared directory 141 with a corresponding peer file shored in a peer shared directory. The processor may copy the corresponding peer file if it is newer than the local file 415. For example, the local file 415 and the corresponding peer file may include status indications 409. The processor 403 may update the local indication 409 by copying the peer shared file if it is newer.

In some implementations, the processor 403 may perform an update procedure for each file in the local shared directory 414. For each local file, the processor 403 may then find the corresponding file in the peer shared directory. For example, the processor 403 may traverse the shared directory 414 and the peer shared directory alphabetically. If the peer shared directory has a newer copy of the file, the processor 403 may copy the file to the local shared directory 414. If the peer shared directory has an older copy, the processor 403 may do nothing. In some implementations, the files may have deletion flags. In these implementations, if the peer file is flagged for deletion and has a later timestamp, the processor 403 may apply a deletion flag to the local file. If the peer file is flagged for deletion, but has a later timestamp, the processor 403 may do nothing. If a new file exists in the peer shared directory that does not have a corresponding file in the shared directory 414, the processor 403 may copy the new file to the shared directory 414.

In some implementations, the processor 403 may use the management network interface 402 to receive a second identification 413 of a second peer system. In some cases, the processor 403 may receive the second identification 413 from the first peer system. For example, the processor 403 may receive the second identification 413 by copying a file 416 when the processor 403 updates the shared directory 414. The processor 403 may use the host interface 406 to provide the second identification 413 of the second peer system to the host system. Additionally, a second status indication 410 may be stored with the second identification 413. In this case, the processor 403 may provide the second status identification 410 to the host system.

In some implementations, the processor 403 may maintain a local file 417 in the shared directory 414. For example, the local file 417 may include a host system identification 411 and a host system status indication 408. In some cases, the host system status indication 408 may be determined using a sensor. 405, such as a temperature sensor. The processor 403 may provide the local file 417 to a peer system during a peer system's shared directory updating procedure.

In the foregoing description, numerous de ails are set forth to provide an understanding of the subject disclosed herein. However, implementations may be practiced without some or all of these details. Other implementations may include modifications and variations from the details discussed above. It is intended that the appended claims cover such modifications and variations.

1. A system, comprising:
a baseboard management controller comprising:
a management network interface to receive an identification of a peer system over a management network;
a first non-transitory computer readable medium to store the identification of the peer system;
a host system interface to provide the identification of the peer system to the host system; and
the host system comprising:
a production network interface to receive an image of a virtual machine hosted by the peer system; and
a second non-transitory computer readable medium to store the image of the virtual machine.

2. The system of claim 1, wherein:
the first non-transitory computer readable medium stores the identification in a shared directory; and
the baseboard management controller further comprises a processor to:
compare the shared directory with a peer shared directory, and
to receive the identification from the peer shared directory over the management network interface.

3. The system of claim 2, wherein:
the processor is to determine that the peer shared directory comprises a plurality of files, and
for each file of the peer shared directory, the processor is to:
determine if there is a corresponding file in the shared directory; and
if there is not a corresponding file in he shared directory, create the corresponding file in the shared directory.

4. The system of claim 1, wherein the identification is store with a peer system status indication.

5. The system of claim 4, wherein:
the baseboard management controller further comprises a processor to:
analyze the peer system status indication to determine if the peer system is offline, and
signal the host system that the peer system is offline; and
the host system further comprises a processor to instantiate the virtual machine using the image.

6. The system of claim 1, wherein:
the management network interface is to receive a request to execute the virtual machine; and
the host system further comprises a processor to instantiate the virtual machine using the image.

7. The system of claim 1, wherein:
the management network interface is to receive a second identification of a second peer system from the first peer system;
the host system interface is to provide the second identification to the host system;
the production network interface is to receive a second image of a second virtual machine hosted by the second peer system; and
the second non-transitory computer readable medium is to store the second image.

8. The system of claim 1, wherein:
the management network interface is to send a second identification of the host system to the peer system over the management network; and
the production network interface is to send a second image of a second virtual machine to the peer system over the production network.

9. The system of claim 8, wherein:
the management network interface is to send a request to execute the second virtual machine to the peer system; and
the host system further comprises a processor to cease executing the second virtual machine.

10. A non-transitory computer readable medium storing instructions that, when executed, implement:
a hypervisor to:
obtain an identification of a peer system from a shared directory stored by a baseboard management controller, and
obtain an image of a virtual machine from the peer system.

11. The non-transitory computer readable medium of claim 10, wherein the instructions, when executed, implement the hypervisor to:
obtain, from the baseboard management controller, an indication that the peer system is offline; and
instantiate the virtual machine using the image.

12. The non-transitory computer readable medium of claim 10, wherein the instructions, when executed, implement the hypervisor to:
obtain a request to instantiate the virtual machine; and
instantiate the virtual machine using the image.

13. The non-transitory computer readable medium of claim 10, wherein the instructions, when executed implement the hypervisor to:
instantiate a second virtual machine;
store a second image of the second virtual machine in the shared file system; and
send the second image to the peer system.

14. A baseboard management controller, comprising:
a non-transitory computer readable medium to store a shared directory, the shared directory comprising an identification of a peer system;
a management network interface to connect to a management network;
a host system interface to connect to a host system; and
a processor to:
receive the identification of the peer system from the peer system over the management network interface, and
provide the identification of the peer system to the host system over the host system interface.

15. The baseboard management controller of claim 14, wherein the processor is to:
update the shared directory by comparing a local file stored in the shared directory with a corresponding peer file stored in a peer shared directory and copying the corresponding peer file if the corresponding peer file is newer than the local file.

16. The baseboard management controller of claim 14, wherein he processor is to:
receive a second identification of a second peer system from the first peer system over the management network interface, and
provide the second identification of the second peer system to the host system over the host system interface.
